(19) United States
(12) Patent Application Publication
(10) Pub. No.: US 2021/0273480 A1
(43) Pub. Date: Sep. 2, 2021

(54) Solid State Power Controller (SSPC) Configured for Automatic Retry and Process of Implementing the Same

(71) Applicant: Data Device Corporation, Bohemia, NY (US)

(72) Inventors: John Santini, Bohemia, NY (US); William Thorp, Bohemia, NY (US); Frank Haunstein, Bohemia, NY (US); James Ianotto, Bohemia, NY (US)

(21) Appl. No.: 17/184,938

(22) Filed: Feb. 25, 2021

Related U.S. Application Data
(60) Provisional application No. 62/982,951, filed on Feb. 28, 2020.

(51) Int. Cl. H02J 9/06; B60L 3/00

(52) U.S. Cl. CPC H02J 9/062; H02J 2310/40; B60L 3/0023; H02J 9/061

(57) ABSTRACT

A power system that includes a power bus; at least one power source system; and the at least one power source system is configured to provide power to the power bus for operation of the at least one powered system. The power system further includes a power controller configured to control power provided by the at least one power source system for operation of the at least one powered system and includes a switch and an energy storage device implemented by the power controller connected to the power bus.

### CROSS-REFERENCE TO RELATED APPLICATIONS

This application claims the benefit from U.S. Provisional Application No. 62/982,951 filed on Feb. 28, 2020, which is hereby incorporated by reference in its entirety for all purposes as if fully set forth herein.

### FIELD OF THE DISCLOSURE

The disclosure relates to Solid State Power Controllers (SSPCs) configured for automatic retry. Additionally, the disclosure relates to a process for implementing Solid State Power Controllers (SSPCs) configured for automatic retry.

### BACKGROUND OF THE DISCLOSURE

Aircraft and other means of transport typically benefit from one or more systems to control power. Prior art systems are typically configured to turn solid state switches on relatively slowly in order to limit an inrush current. This usually means that the switches are forced to dissipate a relatively large amount of power at turn-on and turn-off of the switch, which means a number of field-effect transistor (FET) switches must be paralleled for higher power operation. Additionally, capacitive loads for these prior art systems are also a problem because a peak charging current can be very large, and reaches the peak current limit relatively quickly that results in a switch shut down. This is similar to a circuit breaker that opens upon an overload. Once shut down, the prior art system requires manual intervention as the shutdown is considered a fault. Power dissipation could be limited by shorter switch times, but the shorter switch times cause proportionately higher inrush currents that would eventually reach the instantaneous trip point, leaving the circuit disabled until manually reset.

Accordingly, what is needed is a power controller system implemented in various means of transport to improve power delivery by increasing reliability and preventing shutdowns.

### SUMMARY OF THE DISCLOSURE

The foregoing needs are met, to a great extent, by the disclosure, wherein a Solid State Power Controller (SSPC) is configured for automatic retry for use in aircraft and other means of transport is provided. Moreover, the foregoing needs are met, to a great extent, by the disclosure, wherein a process for implementing a Solid State Power Controller (SSPC) is configured for automatic retry for use in aircraft and other means of transport is provided.

One aspect includes a power system that includes a power bus that includes at least two power lines including a first power line and a second power line providing positive and negative voltage potential; at least one power source system; at least one powered system and the power bus is configured to connect to the at least one powered system; the at least one power source system is configured to provide power to the power bus for operation of the at least one powered system; a power controller configured to control power provided by the at least one power source system for operation of the at least one powered system; a switch implemented by the power controller, the switch being configured to complete a circuit between the at least one power source system and the at least one powered system to control power delivery from the at least one power source system to the at least one powered system; an energy storage device implemented by the power controller connected to the power bus; a current sensor implemented by the power controller; the power controller being configured to turn on the switch; the power controller configured to sense a current on the power bus by the current sensor; the power controller configured compare the current to a peak current limit; the power controller configured to determine that the peak current limit has been reached based on output from the current sensor and the power controller configured to turn off the switch and allow the energy storage device to charge up a load associated with the at least one powered system; and the power controller further configured to operate the switch to automatically turn on again and the at least one power source system is configured to continue to ramp up a load voltage for the at least one powered system.

One aspect includes a process of implementing a power system that includes configuring a power bus that includes at least two power lines including a first power line and a second power line providing positive and negative voltage potential; configuring at least one power source system; configuring at least one powered system and the power bus to connect to the at least one powered system; configuring the at least one power source system to provide power to the power bus for operation of the at least one powered system; configuring a power controller to control power provided by the at least one power source system for operation of the at least one powered system; configuring a switch implemented by the power controller, the switch being configured to complete a circuit between the at least one power source system and the at least one powered system to control power delivery from the at least one power source system to the at least one powered system; configuring an energy storage device implemented by the power controller connected to the power bus; configuring a current sensor implemented by the power controller; turning on the switch with the power controller; sensing a current on the power bus by the current sensor with the power controller; comparing the current to a peak current limit with the power controller; determining that the peak current limit has been reached based on output from the current sensor and the power controller configured to turn off the switch and allow the energy storage device to charge up a load associated with the at least one powered system; and operating the switch to automatically turn on again and the at least one power source system is configured to continue to ramp up a load voltage for the at least one powered system.

The disclosure is directed to a Solid State Power Controller, which circumvents the above-noted problems. The disclosed Solid State Power Controller is configured to permit a reasonable number of retries when a circuit is turned on, allowing the load voltage to “ratchet up.” The disclosed Solid State Power Controller is configured to reduce switching time to be much faster than a purely linear approach, which will minimize power dissipation in the switch. The fast turn-on time will mean the rate of rise of current will be limited by a small internal inductor and the inductance of the load wiring. This will essentially form a switching regulator, which is much more efficient than operating the switches in the linear mode at turn-on. The disclosed Solid State Power Controller is configured to eliminate false trips or greatly reduce false trips produced by switching on into highly capacitive loads. The disclosed Solid State Power Controller is configured to eliminate false tripping or greatly reduce false tripping by allowing “retries” to keep charging up the load capacitance until eventually the load voltage is high enough that the voltage differential between source and load is reduced such that excessive current no longer flows when the switch is closed.

The “turn on” procedure of the disclosed Solid State Power Controller may be configured to be implemented as follows: The switch is turned on in as short a period of time as is practical. The input current begins to rise, at a rate controlled by the applied voltage and the inductance in the load and the wiring to the load. If the peak current limit is reached, the switch turns off for a brief period of time. During this time, the inductive current decays, further charging up the load. Once this current decays, the switch automatically turns on again and continues to ramp up the load voltage. The fast turn-on time will mean the rate of rise of current will be limited only by a small internal inductor and the inductance of the load wiring. The net effect is that load voltage “ratchets up” in a controlled fashion. This curve may be similar in time period to a more conventional linear approach. The number of retries is limited, so that if the maximum number of retries is reached, the switch will remain open in a “tripped” state, similar to the effect of a blown fuse or a tripped circuit breaker.

As an alternate approach to this technique, the turn-on sequence may be modified to include a variable current limit. The circuit may be set up to allow only a low peak current initially, and the allowable current may be increased over time, forming a “soft start” circuit.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 illustrates an exemplary electrical power system for aircraft and other means of transport in accordance with aspects of the disclosure.

FIG. 2 illustrates an exemplary implementation of a Solid State Power Controller (SSPC) in accordance with aspects of the disclosure.

FIG. 3 illustrates an exemplary implementation of a Solid State Power Controller (SSPC) in accordance with aspects of the disclosure.

FIG. 4 illustrates an exemplary process for implementation of a Solid State Power Controller (SSPC) in accordance with aspects of the disclosure.

### DETAILED DESCRIPTION

The disclosure will now be described with reference to the drawing Figures, in which like reference numerals refer to like parts throughout. Aspects of the disclosure advantageously provide a Solid State Power Controller (SSPC) configured for automatic retry for use in aircraft and other means of transport; and a process for implementing a Solid State Power Controller (SSPC) configured for automatic retry for use in aircraft and other means of transport.

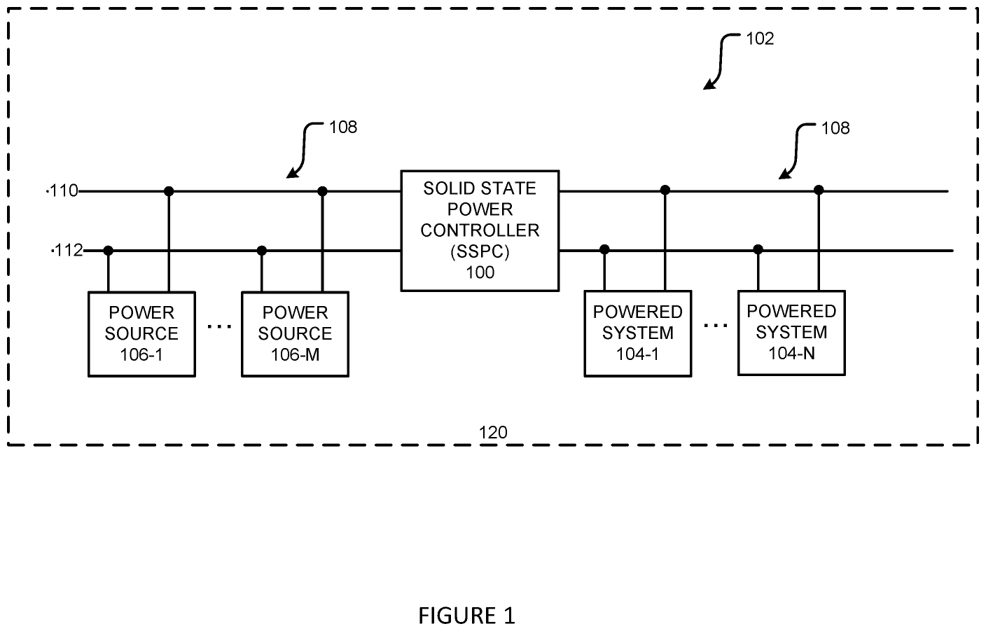

FIG. 1 illustrates an exemplary electrical power system for an aircraft and other means of transport in accordance with aspects of the disclosure.

FIG. 1 illustrates an exemplary power system. For simplicity and the brevity of the disclosure, the exemplary power system is illustrated with a high level of simplification. Moreover, although reference is made to an implementation in aircraft, the disclosure is equally applicable to implementations in other types of vehicles including ground-based vehicles, undersea vehicles, ships, space craft, and/or the like, as well as other systems benefiting from supplying power. For example, systems implemented in trains, buses, helicopters, subways, and/or the like providing power to devices and/or the like. For simplicity and brevity of the disclosure, the exemplary power system is further described herein as an aircraft power system 102 that may be implemented in aircraft 120.

In particular, FIG. 1 illustrates an aircraft power system 102. The aircraft power system 102 may include an aircraft power bus 108. The aircraft power bus 108 may include at least two power lines including a first power line 110 and a second power line 112 providing positive and negative voltage potential. The aircraft power bus 108 may include additional power lines depending on the application and associated design. The aircraft power bus 108 may extend along at least a portion of the aircraft 120 internally connecting to various aircraft systems.

The aircraft power system 102 may further include at least one power source system 106 (power source system 106-1 through power source system 106-M, wherein M is a positive integer). The power source system 106 may receive power from a generator associated with an auxiliary power unit, a generator associated with an aircraft engine, a generator associated with a turbine, a generator associated with a high bypass turbine, an external power source, and/or the like.

Additionally, the aircraft power bus 108 may connect to a powered aircraft system 104 (powered aircraft system 104-1 through powered aircraft system 104-N, where N is a positive integer). The powered aircraft system 104 may include flight control systems, landing gear systems, electrical systems, bleed systems, hydraulic systems, avionics systems, supplemental oxygen systems, fuel systems, power plant systems, navigation systems, communication systems, ice protection systems (anti-icing and deicing), environmental control systems, instrumentation and recording systems, vacuum systems, fire protection systems, safety systems, universal serial bus (USB-PD (Power Delivery)) outlets, and/or the like. Each of the powered aircraft system 104 may need electrical power for operation of one or more aspects thereof. Accordingly, the powered aircraft system 104 may connect to the aircraft power bus 108 to receive power. For example, in one aspect the powered aircraft system 104 may include an auxiliary power unit that requires power for starting. As another example, in one aspect the powered aircraft system 104 may include a turbine unit that requires power for starting. When operational, the power source system 106 provides power to the aircraft power bus 108 for operation of the powered aircraft system 104.

Additionally, the aircraft power bus 108 may include a Solid State Power Controller (SSPC) 100. As further described herein, the Solid State Power Controller (SSPC) 100 may be configured to control power provided by the power source system 106 for operation of the powered aircraft system 104.

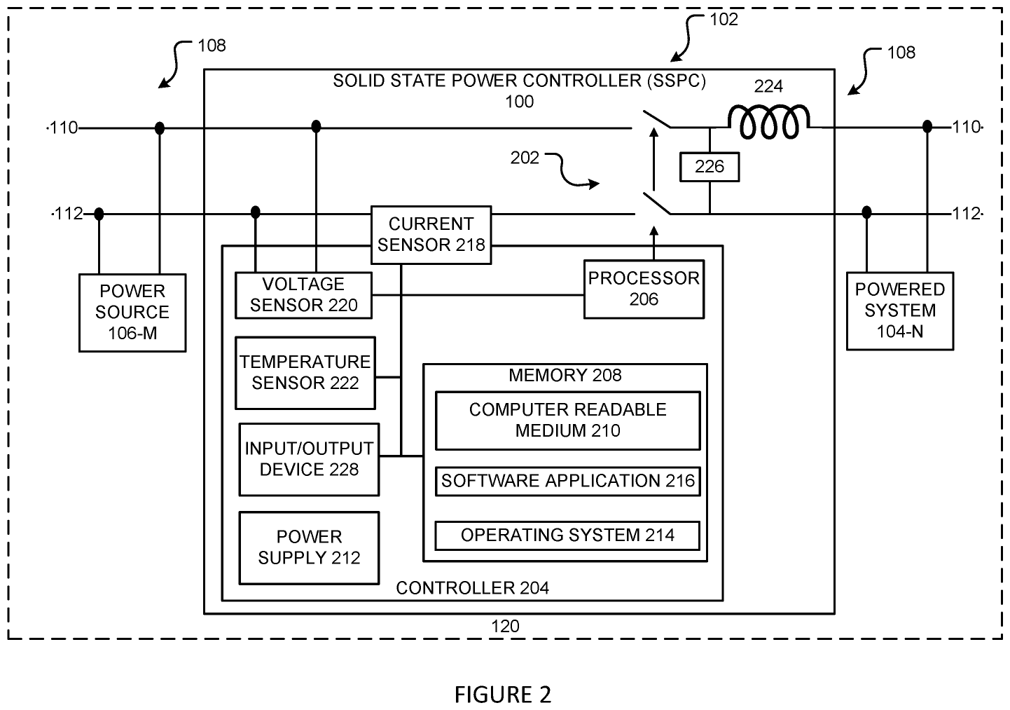

FIG. 2 illustrates an exemplary implementation of a Solid State Power Controller (SSPC) in accordance with aspects of the disclosure.

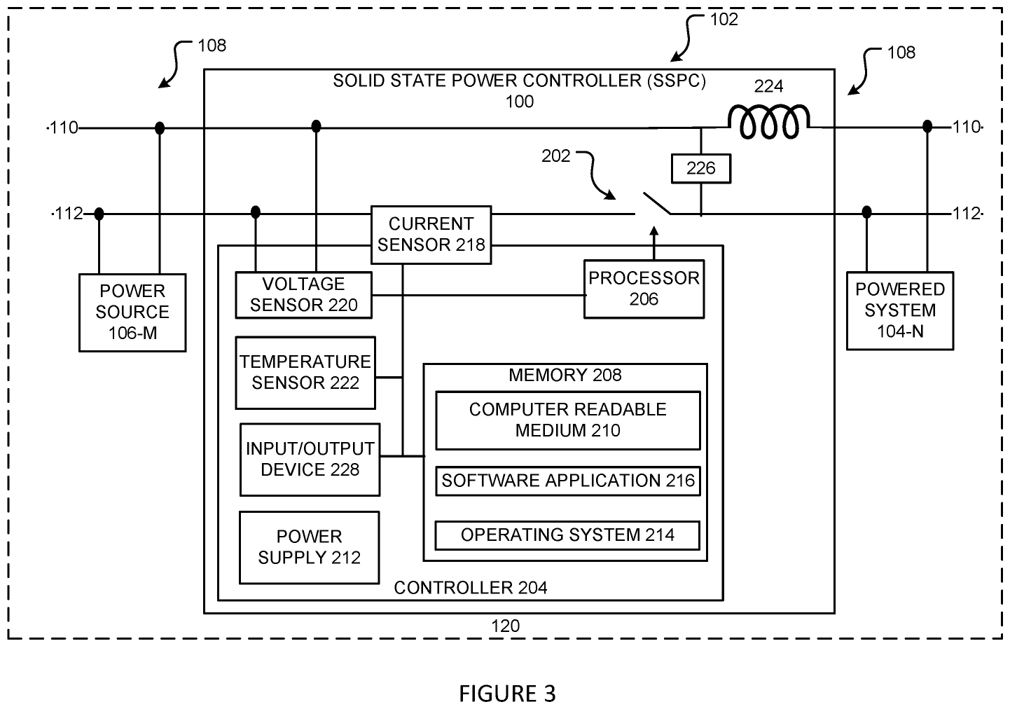

FIG. 3 illustrates an exemplary implementation of a Solid State Power Controller (SSPC) in accordance with aspects of the disclosure.

In particular, FIG. 2 and FIG. 3 illustrate details of the Solid State Power Controller (SSPC) 100. The Solid State Power Controller (SSPC) 100 may include a switch 202. The switch 202 may complete a circuit between the power source system 106 and the powered aircraft system 104 to control power delivery from the power source system 106 to the powered aircraft system 104. In one aspect as illustrated in FIG. 2, the switch 202 may include two parallel switches, one on the first power line 110 and one on the second power line 112 for connecting the power source system 106 and the powered aircraft system 104 to provide power from the power source system 106 to the powered aircraft system 104. The switch 202 may include a single switch or a plurality of parallel switches.

In one aspect as illustrated in FIG. 3, the switch 202 may include a single switch, one on the first power line 110 or alternatively one on the second power line 112 (not shown) for connecting the power source system 106 and the powered aircraft system 104 to control power delivery from the power source system 106 to the powered aircraft system 104. The switch 202 may include a single switch or a plurality of parallel switches.

The switch 202 may be implemented and/or may include one or more of a field-effect transistor (FET), a wide band-gap transistor device, an ultra-wideband transistor device, a GaN based transistor device, a Metal Semiconductor Field-Effect Transistor (MESFET) device, a Metal Oxide Field Effect Transistor (MOSFET) device, a Junction Field Effect Transistor (JFET) device, a laterally-diffused metal-oxide semiconductor (LDMOS) transistor device, a Bipolar Junction Transistor (BJT) device, an Insulated Gate Bipolar Transistor (IGBT) device, a high-electron-mobility transistor (HEMT) device, a Wide Band Gap (WBG) semiconductor device, and/or the like.

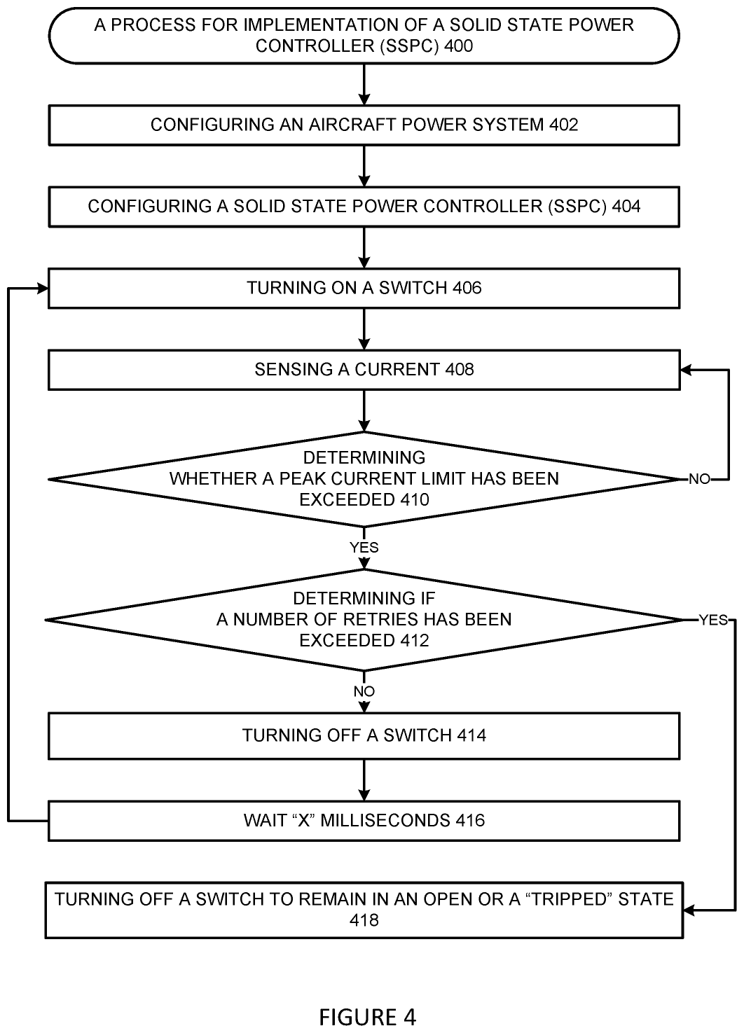

The Solid State Power Controller (SSPC) 100 may include a controller 204. The controller 204 may include a processor 206 and may be implemented as a computer system that may include a memory 208, a display, a transceiver, a user interface, and the like. The processor 206 may be configured to process functions, provide other services, and the like. The computer system may further include a user interface, an input/output device 228, a computer readable medium 210, and a power supply 212. Additionally, the computer system may implement an operating system 214, a touchscreen controller, a communications component, a graphics component, a contact/motion component, and the like to provide full functionality. In particular, the processor 206 may be configured to execute a software application 216 configured to control the Solid State Power Controller (SSPC) 100 by the controller 204. In one aspect, the software application 216 may be configured to interact with sensors, aircraft systems, and/or the like. In one aspect, the software application 216 may be configured to implement a process for implementation of a Solid State Power Controller (SSPC) 400 illustrated in FIG. 4 and described below.

The Solid State Power Controller (SSPC) 100 may further include an energy storage device 224 arranged on and/or connected to the aircraft power bus 108. The energy storage device 224 may be arranged in series on the first power line 110 and/or the second power line 112. The energy storage device 224 may be arranged in series between the power source system 106 and the powered aircraft system 104. The energy storage device 224 may be configured as an inductor. However, the energy storage device 224 may be implemented utilizing other components such as capacitors, super capacitors, and/or the like and may be implemented utilizing other circuit configurations configured to provide stored energy from an energy storage device.

The Solid State Power Controller (SSPC) 100 may further include a circuit 226. The circuit 226 may be configured to complete a circuit between the first power line 110, the energy storage device 224, the powered aircraft system 104, and the second power line 112. The circuit 226 may be configured to be operative only once the switch 202 is opened. The circuit 226 may be configured to allow the energy storage device 224 to charge the powered aircraft system 104. In aspects, the circuit 226 may be implemented as a diode or a flyback diode. In aspects, the circuit 226 may be implemented as a switch. However, the circuit 226 may be implemented utilizing other components and may be implemented utilizing other circuit configurations configured to provide stored energy from an energy storage device 224.

The Solid State Power Controller (SSPC) 100 may further include one or more sensors to sense a condition of the aircraft power system 102, the power source system 106, the powered aircraft system 104, an aircraft system, or the like. In particular, the one or more sensors may provide signals to the processor 206. The one or more sensors may include a current sensor 218, a voltage sensor 220, a temperature sensor 222, and/or the like.

The Solid State Power Controller (SSPC) 100 implementing the controller 204 may implement a “turn on” procedure. The “turn on” procedure may include the controller 204 operating the switch 202 of the Solid State Power Controller (SSPC) 100 such that the switch 202 is turned on. In one aspect, the controller 204 operating the switch 202 of the Solid State Power Controller (SSPC) 100 may operate such that the switch 202 is turned on in as short a period of time as is practical.

Once the Solid State Power Controller (SSPC) 100 turns on the switch 202, input current from the power source system 106 may begin to rise, at a rate controlled by the applied voltage of the power source system 106, an inductance in the load, such as the inductance in the powered aircraft system 104, and the inductance in the wiring to the load, such as the inductance in the wiring to the powered aircraft system 104. Additionally, the energy storage device 224 may also receive an input current from the power source system 106 and start to store power. The Solid State Power Controller (SSPC) 100 may sense the voltage on the aircraft power bus 108 with the voltage sensor 220 and the current on the aircraft power bus 108 by the current sensor 218. The Solid State Power Controller (SSPC) 100 may include values stored in the memory 208 that include a peak current limit. The Solid State Power Controller (SSPC) 100 may sense the current on the aircraft power bus 108 by the current sensor 218 and compare the current to the peak current limit stored in the memory 208. However, the Solid State Power Controller (SSPC) 100 may sense other electrical characteristics on the aircraft power bus 108 with one or more sensors and compare the electrical characteristics for operation thereof.

If the Solid State Power Controller (SSPC) 100 determines that the peak current limit has been reached based on output from the current sensor 218, the Solid State Power Controller (SSPC) 100 and/or the controller 204 may operate the switch 202 and the switch 202 may be turned off for a brief period of time. During this time, the energy storage device 224 may still be connected to the powered aircraft system 104 and as an associated inductive current decays, the energy storage device 224 may continue to further charge up the load associated with the powered aircraft system 104. In this regard, the energy storage device 224 may be connected to the powered aircraft system 104 by the first power line 110, the second power line 112, and/or the circuit 226 such that the energy storage device 224 may continue to charge up the load associated with the powered aircraft system 104.

Once the current of the energy storage device 224 decays, the Solid State Power Controller (SSPC) 100 and/or the controller 204 may operate the switch 202 to automatically turn on again and the power source system 106 may continue to ramp up the load voltage for the powered aircraft system 104. The fast turn-on time of the Solid State Power Controller (SSPC) 100 and/or the controller 204 in conjunction with the switch 202 will mean the rate of rise of current to the powered aircraft system 104 will be limited only by the energy storage device 224, which may be implemented as a small internal inductor and the inductance of the load wiring.

The Solid State Power Controller (SSPC) 100 and/or the controller 204 may be configured to repeatedly turn on and turn off the switch 202. In other words, the Solid State Power Controller (SSPC) 100 and/or the controller 204 may be configured to retry turning on and thereafter if needed turning off the switch 202. The net effect of the operation of the Solid State Power Controller (SSPC) 100, the controller 204, and the switch 202 allows the load voltage to “ratchet up” in a controlled fashion. The resulting curve of power versus time provided to the powered aircraft system 104 may be similar in time period to a more conventional linear approach.

The number of retries of the Solid State Power Controller (SSPC) 100 and/or the controller 204 turning on and thereafter if needed turning off the switch 202 may be limited. In particular, the Solid State Power Controller (SSPC) 100 and/or the controller 204 turning on and thereafter if needed turning off the switch 202 may be repeated until a maximum number of retries is reached. Thereafter, the Solid State Power Controller (SSPC) 100 and/or the controller 204 may operate the switch 202 to remain in an open or a “tripped” state. In one aspect, the Solid State Power Controller (SSPC) 100 and/or the controller 204 may operate the switch 202 to remain open similar to the effect of a blown fuse or a tripped circuit breaker.

As an alternate approach to this technique, the Solid State Power Controller (SSPC) 100 and/or the controller 204 may operate the switch 202 such that the turn-on sequence may be modified to include a variable current limit. In this regard, the Solid State Power Controller (SSPC) 100 and/or the controller 204 may operate the switch 202 in conjunction with the current sensor 218 to allow only a low peak current initially, and the allowable current may be increased over time, forming a “soft start” implementation of the Solid State Power Controller (SSPC) 100.

The Solid State Power Controller (SSPC) 100 of the disclosure may be configured to permit a reasonable number of retries when the switch 202 and associated circuitry is turned on. In this regard, the Solid State Power Controller (SSPC) 100 may allow the load voltage of the powered aircraft system 104 to “ratchet up.” The Solid State Power Controller (SSPC) 100 of the disclosure may be configured to reduce switching time to be much faster than a purely linear approach, which will minimize power dissipation in the switch 202. The fast turn-on time will mean the rate of rise of current will be limited by the energy storage device 224, which may be implemented a small internal inductor and the inductance of the load wiring. The Solid State Power Controller (SSPC) 100, the switch 202, the energy storage device 224, and/or the like may essentially form a switching regulator, which is much more efficient than operating the switches in the linear mode at turn-on.

The Solid State Power Controller (SSPC) 100 of the disclosure may be configured to eliminate false trips or greatly reduce false trips produced by switching on into highly capacitive loads. The Solid State Power Controller (SSPC) 100 of the disclosure may be configured to eliminate false tripping or greatly reduce false tripping by allowing “retries” to keep charging up the load capacitance until eventually the load voltage is high enough that the voltage differential between source, such as the power source system 106, and the load, such as the powered aircraft system 104, is reduced such that excessive current no longer flows when the switch 202 of the Solid State Power Controller (SSPC) 100 is closed.

FIG. 4 illustrates an exemplary process for implementation of a Solid State Power Controller (SSPC) in accordance with aspects of the disclosure.

In particular, FIG. 4 illustrates a process for implementation of a Solid State Power Controller (SSPC) 400. It should be noted that the aspects of the process for implementation of a Solid State Power Controller (SSPC) 400 may be performed in a different order consistent with the aspects described herein. Moreover, the process for implementation of a Solid State Power Controller (SSPC) 400 may be modified to have more or fewer processes consistent with the various aspects disclosed herein. In one aspect, the process for implementation of a Solid State Power Controller (SSPC) 400 may be performed by the software application 216 executed by the processor 206.

Initially, the process for implementation of a Solid State Power Controller (SSPC) 400 may include a process of configuring an aircraft power system 402. The process of configuring an aircraft power system 402 may include configuring the aircraft power system 102, the aircraft power bus 108, the first power line 110, the second power line 112, the at least one power source system 106, the powered aircraft system 104, and/or the like constructed, configured, and/or arranged as described herein.

The process for implementation of a Solid State Power Controller (SSPC) 400 may include a process of configuring a Solid State Power Controller (SSPC) 404. The process of configuring a Solid State Power Controller (SSPC) 404 may include configuring the Solid State Power Controller (SSPC) 100 constructed, configured, and/or arranged as described herein to control power provided by the power source system 106 for operation of the powered aircraft system 104 and/or the like.

The process for implementation of a Solid State Power Controller (SSPC) 400 may include a process of turning on a switch 406. The process of turning on a switch 406 may include the controller 204 operating the switch 202 of the Solid State Power Controller (SSPC) 100 such that the switch 202 is turned on. In one aspect, the Solid State Power Controller (SSPC) 100 may operate such that the switch 202 is turned on in as short a period of time as is practical.

Once the Solid State Power Controller (SSPC) 100 turns on the switch 202, an input current from the power source system 106 may begin to rise at a rate controlled by the applied voltage of the power source system 106, an inductance in the load, such as the inductance in the powered aircraft system 104, and the inductance in the wiring to the load, such as the inductance in the wiring to the powered aircraft system 104. Additionally, the energy storage device 224 may also receive an input current from the power source system 106 and start to store power.

The process for implementation of a Solid State Power Controller (SSPC) 400 may include a process of sensing a current 408. The process of sensing a current 408 may include the Solid State Power Controller (SSPC) 100 sensing the current on the aircraft power bus 108 by the current sensor 218. The Solid State Power Controller (SSPC) 100 may include values stored in the memory 208 that include a peak current limit.

The process for implementation of a Solid State Power Controller (SSPC) 400 may include a process of determining whether a peak current limit has been exceeded 410. The Solid State Power Controller (SSPC) 100 may sense the current on the aircraft power bus 108 by the current sensor 218 and compare the current to the peak current limit stored in the memory 208. Other electrical characteristics may be alternatively and/or additionally sensed and compared.

If the Solid State Power Controller (SSPC) 100 determines the current on the aircraft power bus 108 by the current sensor 218 exceeds the peak current limit stored in the memory 208, then the process advances to box 412.

If the Solid State Power Controller (SSPC) 100 determines the current on the aircraft power bus 108 by the current sensor 218 does not exceed the peak current limit stored in the memory 208, then the process returns to box 408.

The process for implementation of a Solid State Power Controller (SSPC) 400 may include a process of determining if a number of retries has been exceeded 412. If the number of retries has been exceeded, the process for implementation of a Solid State Power Controller (SSPC) 400 may advance to box 418. On the other hand, if the number of retries has not been exceeded, the process for implementation of a Solid State Power Controller (SSPC) 400 may advance to box 414.

The process for implementation of a Solid State Power Controller (SSPC) 400 may include a process of turning off a switch 414. If the Solid State Power Controller (SSPC) 100 determines that the peak current limit is reached based on output from the current sensor 218, the Solid State Power Controller (SSPC) 100 and/or the controller 204 may operate the switch 202 and the switch 202 may be turned off for a brief period of time. During this time, the energy storage device 224 may still be connected to the powered aircraft system 104 and as an associated inductive current decays, the energy storage device 224 may continue to further charge up the load associated with the powered aircraft system 104.

After the process of turning off a switch 414, the process for implementation of a Solid State Power Controller (SSPC) 400 may advance to box 416. In box 416, the process for implementation of a Solid State Power Controller (SSPC) 400 may wait “X” milliseconds. The value of “X” may be dependent on the sensed current, the particular implementation of the power source system 106, the particular implementation of the powered aircraft system 104, the particular implementation of the aircraft power system 102, the particular implementation of the Solid State Power Controller (SSPC) 100 and/or the like. After waiting “X” milliseconds, the process for implementation of a Solid State Power Controller (SSPC) 400 may return to box 406.

The process for implementation of a Solid State Power Controller (SSPC) 400 may include a process of turning off a switch to remain in an open or a “tripped” state 418. The number of retries of the Solid State Power Controller (SSPC) 100 and/or the controller 204 turning on and thereafter if needed turning off the switch 202 may be limited. In particular, the Solid State Power Controller (SSPC) 100 and/or the controller 204 turning on and thereafter if needed turning off the switch 202 may be repeated until a maximum number of retries is reached. Thereafter, the Solid State Power Controller (SSPC) 100 and/or the controller 204 may operate the switch 202 to remain in an open or a “tripped” state. In one aspect, the Solid State Power Controller (SSPC) 100 and/or the controller 204 may operate the switch 202 to remain open similar to the effect of a blown fuse or a tripped circuit breaker.

The Solid State Power Controller (SSPC) 100 of the disclosure may be configured to permit a reasonable number of retries when the switch 202 and associated circuitry is turned on. In this regard, the Solid State Power Controller (SSPC) 100 may allow the load voltage of the powered aircraft system 104 to “ratchet up.” The Solid State Power Controller (SSPC) 100 of the disclosure may be configured to reduce switching time to be much faster than a purely linear approach, which will minimize power dissipation in the switch 202. The fast turn-on time will mean the rate of rise of current will be limited by the energy storage device 224, which may be implemented a small internal inductor and the inductance of the load wiring. The Solid State Power Controller (SSPC) 100, the switch 202, the energy storage device 224, and/or the like may essentially form a switching regulator, which is much more efficient than operating the switches in the linear mode at turn-on.

The Solid State Power Controller (SSPC) 100 of the disclosure may be configured to eliminate false trips or greatly reduce false trips produced by switching on into highly capacitive loads. The Solid State Power Controller (SSPC) 100 of the disclosure may be configured to eliminate false tripping or greatly reduce false tripping by allowing “retries” to keep charging up the load capacitance until eventually the load voltage is high enough that the voltage differential between source, such as the power source system 106, and the load, such as the powered aircraft system 104, is reduced such that excessive current no longer flows when the switch 202 of the Solid State Power Controller (SSPC) 100 is closed.

The Solid State Power Controller (SSPC) 100 may include one or more of a DC to DC converter, voltage regulator, fuses, ground fault circuit interrupter, temperature sensing circuits, voltage sensing circuits, and/or the like. The DC to DC converter converts a source of direct current (DC) from one voltage level to another as needed within the Solid State Power Controller (SSPC) 100. The voltage regulator may be configured to provide a stable DC voltage independent of the load current, temperature, and/or the like as needed within the Solid State Power Controller (SSPC) 100. The one or more fuses may be configured to protect against excessive current as needed within the Solid State Power Controller (SSPC) 100. The ground fault circuit interrupter (GFCI) may be configured to break an electric circuit to prevent serious harm from an ongoing electric shock as needed within the Solid State Power Controller (SSPC) 100. The Solid State Power Controller (SSPC) 100 may be configured to utilize outputs from the temperature or voltage sensing circuits monitored by the controller to safely operate.

The Solid State Power Controller (SSPC) 100 may be configured to implement various safety protections. The safety protections implemented by the Solid State Power Controller (SSPC) 100 may include over voltage protection, over current protections, overheat protections, short-circuit protections, and/or the like.

The aircraft power system 102 may include one or more of a rectifier, DC to DC converter, transformer, voltage regulator, fuses, ground fault circuit interrupter, temperature sensing circuits, voltage sensing circuits, and/or the like. The rectifier may be configured to convert alternating current (AC) to direct current (DC) as needed within the aircraft power system 102. The DC to DC converter converts a source of direct current (DC) from one voltage level to another as needed within the aircraft power system 102. The transformer may be configured to step up or step down the alternating current (AC) as needed within the aircraft power system 102. The voltage regulator may be configured to provide a stable DC voltage independent of the load current, temperature, and AC power source variations as needed within the aircraft power system 102. The one or more fuses may be configured to protect against excessive current as needed within the aircraft power system 102. The ground fault circuit interrupter (GFCI) may be configured to break an electric circuit to prevent serious harm from an ongoing electric shock as needed within the aircraft power system 102.

The aircraft power system 102 may be configured to utilize outputs from the temperature or voltage sensing circuits monitored by the controller to safely operate. The aircraft power system 102 may be configured to implement various safety protections. The safety protections implemented by the aircraft power system 102 may include over voltage protection, over current protections, overheat protections, short-circuit protections, and like.

In one aspect, the aircraft power system 102 and/or the Solid State Power Controller (SSPC) 100 may operate in response to an aircraft system. The aircraft system may be a central maintenance system (CMS), a flight management system (FMS), a flight warning system (FWS), a cabin management system, or the like.

The aircraft power system 102, the Solid State Power Controller (SSPC) 100, and/or the processor 206 may include Built-in test equipment (BITE). The Built-in test equipment (BITE) may be configured to address fault management and include diagnostic equipment built into airborne systems to support maintenance processes. The Built-in test equipment (BITE) may include sensors, multimeters, oscilloscopes, discharge probes, frequency generators, and/or the like to enable testing and perform diagnostics. The Built-in test equipment (BITE) may include the detection of the fault, the accommodation of the fault (how the system actively responds to the fault), the annunciation or logging of the fault to warn of possible effects and/or aid in troubleshooting the faulty equipment, or the like.

The Solid State Power Controller (SSPC) 100 and/or one or more components of the Solid State Power Controller (SSPC) 100 may include a housing assembly that may be hermetically sealed to prevent intrusion of foreign objects. In one aspect, the housing assembly may be waterproof, watertight, water resistant and/or the like to prevent intrusion of water and other liquids present in the environment of the housing assembly. In this regard, the housing assembly may include one or more seals, gaskets, adhesives, waterproof coatings, potting materials, and/or the like.

In some aspects, the Solid State Power Controller (SSPC) 100 and/or one or more components of the Solid State Power Controller (SSPC) 100 may be configured on or connected to (as defined herein) a circuit board, a laminated substrate, a printed circuit board (PCB), a printed wire assembly, a surface that mechanically supports and electrically connects the various electronic components or electrical components, and/or the like within the Solid State Power Controller (SSPC) 100.

In one aspect, the Solid State Power Controller (SSPC) 100 and/or one or more components of the Solid State Power Controller (SSPC) 100 may be configured as a Line-Replaceable Unit (LRU) that may be connected to the aircraft power lines and/or signal lines. The Line-Replaceable Unit (LRU) configuration may be a modular component of the airplane that may be designed to be replaced quickly at an operating location. In this regard, the Solid State Power Controller (SSPC) 100 may be mechanically installed and electrically connected to (as defined herein) the aircraft.

Connected as described herein may include coupling or connections that may include leads, wire bonding, an adhesive, soldering, sintering, eutectic bonding, thermal compression bonding, ultrasonic bonding/welding, a clip component, and/or the like as described herein. The connection may be through intervening structures or components or the connection may be a direct connection.

The adhesive of the disclosure may be utilized in an adhesive bonding process that may include applying an intermediate layer to connect surfaces to be connected. The adhesive may be organic or inorganic; and the adhesive may be deposited on one or both surfaces of the surface to be connected. The adhesive may be utilized in an adhesive bonding process that may include applying adhesive material with a particular coating thickness, at a particular bonding temperature, for a particular processing time while in an environment that may include applying a particular tool pressure. In one aspect, the adhesive may be a conductive adhesive, an epoxy-based adhesive, a conductive epoxy-based adhesive, and/or the like.

The solder of the disclosure may be utilized to form a solder interface that may include solder and/or be formed from solder. The solder may be any fusible metal alloy that may be used to form a bond between surfaces to be connected. The solder may be a lead-free solder, a lead solder, a eutectic solder, or the like. The lead-free solder may contain tin, copper, silver, bismuth, indium, zinc, antimony, traces of other metals, and/or the like. The lead solder may contain lead, other metals such as tin, silver, and/or the like. The solder may further include flux as needed.

The sintering of the disclosure may utilize a process of compacting and forming a solid mass of material by heat and/or pressure. The sintering process may operate without melting the material to the point of liquefaction. The sintering process may include sintering of metallic powders. The sintering process may include sintering in a vacuum. The sintering process may include sintering with the use of a protective gas.

The eutectic bonding of the disclosure may utilize a bonding process with an intermediate metal layer that may form a eutectic system. The eutectic system may be used between surfaces to be connected. The eutectic bonding may utilize eutectic metals that may be alloys that transform from solid to liquid state, or from liquid to solid state, at a specific composition and temperature without passing a two-phase equilibrium. The eutectic alloys may be deposited by sputtering, dual source evaporation, electroplating, and/or the like.

The ultrasonically welding of the disclosure may utilize a process whereby high-frequency ultrasonic acoustic vibrations are locally applied to components being held together under pressure. The ultrasonically welding may create a solid-state weld between surfaces to be connected. In one aspect, the ultrasonically welding may include applying a sonicated force.

Accordingly, the disclosure has set forth a power controller system implemented in various means of transport that improves power delivery by increasing reliability. Additionally, the disclosure has set forth a power controller system implemented in various means of transport that improves power delivery by preventing and/or reducing shutdowns.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

The many features and advantages of the disclosure are apparent from the detailed specification, and, thus, it is intended by the appended claims to cover all such features and advantages of the disclosure, which fall within the true spirit, and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A power system comprising:
a power bus that includes at least two power lines including a first power line and a second power line providing positive and negative voltage potential;
at least one power source system;
at least one powered system and the power bus is configured to connect to the at least one powered system;
the at least one power source system is configured to provide power to the power bus for operation of the at least one powered system;
a power controller configured to control power provided by the at least one power source system for operation of the at least one powered system;
a switch implemented by the power controller, the switch being configured to complete a circuit between the at least one power source system and the at least one powered system to control power delivery from the at least one power source system to the at least one powered system;
an energy storage device implemented by the power controller connected to the power bus;
a current sensor implemented by the power controller;
the power controller being configured to turn on the switch;
the power controller configured to sense a current on the power bus by the current sensor;
the power controller configured to compare the current to a peak current limit;
the power controller configured to determine that the peak current limit has been reached based on output from the current sensor and the power controller configured to turn off the switch and allow the energy storage device to charge up a load associated with the at least one powered system; and
the power controller further configured to operate the switch to automatically turn on again and the at least one power source system is configured to continue to ramp up a load voltage for the at least one powered system.

2. The power system according to claim 1 wherein the power controller is configured to repeatedly turn on and turn off the switch.

3. The power system according to claim 1 wherein the energy storage device is configured as an inductor.

4. The power system according to claim 1 wherein the power controller is configured to turn on and turn off the switch until a maximum number of retries is reached.

5. The power system according to claim 1 wherein the power controller is configured to turn on and turn off the switch until a maximum number of retries is reached and thereafter the power controller operates the switch to remain in an open state.

6. The power system according to claim 1 wherein the power controller is configured to operate the switch based on a variable current limit.

7. The power system according to claim 1 wherein the energy storage device is arranged in series on one of the following: the first power line and the second power line.

8. The power system according to claim 1 wherein the energy storage device is arranged in series between the at least one power source system and the at least one powered system.

9. The power system according to claim 1 wherein:
the power controller is configured to repeatedly turn on and turn off the switch;
the energy storage device is configured as an inductor;
the power controller is configured to turn on and turn off the switch until a maximum number of retries is reached; and
the power controller is configured to turn on and turn off the switch until a maximum number of retries is reached and thereafter the power controller operates the switch to remain in an open state.

10. The power system according to claim 1 wherein the power system is configured as one of the following: an aircraft power system, a ground-based vehicle power system, an undersea vehicle power system, a ship power system, and a space craft power system.

11. A process of implementing a power system comprising:
configuring a power bus that includes at least two power lines including a first power line and a second power line providing positive and negative voltage potential;
configuring at least one power source system;
configuring at least one powered system and the power bus to connect to the at least one powered system;
configuring the at least one power source system to provide power to the power bus for operation of the at least one powered system;
configuring a power controller to control power provided by the at least one power source system for operation of the at least one powered system;
configuring a switch implemented by the power controller, the switch being configured to complete a circuit between the at least one power source system and the at least one powered system to control power delivery from the at least one power source system to the at least one powered system;
configuring an energy storage device implemented by the power controller connected to the power bus;
configuring a current sensor implemented by the power controller;
turning on the switch with the power controller;
sensing a current on the power bus by the current sensor with the power controller;
comparing the current to a peak current limit with the power controller;
determining that the peak current limit has been reached based on output from the current sensor and the power controller configured to turn off the switch and allow the energy storage device to charge up a load associated with the at least one powered system; and
operating the switch to automatically turn on again and the at least one power source system is configured to continue to ramp up a load voltage for the at least one powered system.

12. The process of implementing a power system according to claim 11 wherein the power controller is configured to repeatedly turn on and turn off the switch.

13. The process of implementing a power system according to claim 11 wherein the energy storage device is configured as an inductor.

14. The process of implementing a power system according to claim 11 wherein the power controller is configured to turn on and turn off the switch until a maximum number of retries is reached.

15. The process of implementing a power system according to claim 11 wherein the power controller is configured to turn on and turn off the switch until a maximum number of retries is reached and thereafter the power controller operates the switch to remain in an open state.

16. The process of implementing a power system according to claim 11 wherein the power controller is configured to operate the switch based on a variable current limit.

17. The process of implementing a power system according to claim 11 wherein the energy storage device is arranged in series on one of the following: the first power line and the second power line.

18. The process of implementing a power system according to claim 11 wherein the energy storage device is arranged in series between the at least one power source system and the at least one powered system.

19. The process of implementing a power system according to claim 11 wherein:
the power controller is configured to repeatedly turn on and turn off the switch;
the energy storage device is configured as an inductor;
the power controller is configured to turn on and turn off the switch until a maximum number of retries is reached; and
the power controller is configured to turn on and turn off the switch until a maximum number of retries is reached and thereafter the power controller operates the switch to remain in an open state.

20. The process of implementing a power system according to claim 11 wherein the power system is configured as one of the following: an aircraft power system, a ground-based vehicle power system, an undersea vehicle power system, a ship power system, and a space craft power system.
